(19) United States
(12) Patent Application Publication
(10) Pub. No.: US 2025/0342136 A1
(43) Pub. Date: Nov. 6, 2025

(54) CHIPLET COMPOSABILITY

(71) Applicant: Openchip & Software Technologies S.L., Barcelona (ES)

(72) Inventors: Francesc Guim Bernat, Barcelona (ES); Violante Moschiano, Avezzano (IT); Edgar Gonzalez Pellicer, Girona (ES); Gaspar Mora Porta, Castellon de la Plana (ES); Tommaso Vali, Sezze (IT); Satoru Tagaya, Barcelona (ES); Erich Ludwig Focht, Stuttgart (DE)

(21) Appl. No.: 19/269,515

(22) Filed: Jul. 15, 2025

Related U.S. Application Data
(63) Continuation of application No. PCT/EP2025/058767, filed on Mar. 31, 2025.

(51) Int. Cl. G06F 15/78; G06F 13/42

(52) U.S. Cl. CPC G06F 15/7817; G06F 13/4282; G06F 2213/0026

(57) ABSTRACT

Aspects of composing individual chiplet across packages or devices are described. An input-output (IO) hub within a chiplet assembly facilitates external access to individual chiplets by receiving a request from an external entity. The IO hub processes the request by translating a first identifier into a second identifier that uniquely identifies a chiplet within the assembly. The request is then routed to the designated chiplet for execution based on the second identifier. This approach enables dynamic chiplet allocation, enhances resource composability, and supports efficient communication between external systems and chiplet-based architectures.

### PRIORITY

This application is a continuation of International Application No. PCT/EP2025/058767, filed Mar. 31, 2025, which is incorporated herein by reference in its entirety.

### BACKGROUND

Computer system composability is the ability to configure hardware resources, such as processors, memory, storage, or accelerators, into logical systems. Composability can use interconnect standards, such as Compute Express Link (CXL), to enable resource pooling or sharing across devices connected via PCle or other interfaces. Composability provides flexibility over traditional monolithic architectures, enabling resources to operate independently or as part of a larger system. Composability can include mechanisms for resource virtualization, such as virtual functions (VFs), to expose discrete devices (e.g., Network Interface Cards (NICs) or Graphics Processing Units (GPUs)) to hosts for shared use.

Compute Express Link (CXL) and similar interfaces, such as PCIe, are high-performance interconnect standards designed to enable efficient communication between processors, memory, accelerators, or other devices. These interfaces operate by establishing a low-latency, high-bandwidth connection that supports memory coherency and resource sharing. CXL builds upon PCIe's physical layer while introducing additional protocols, such as CXL.io, CXL.cache, and CXL.memory, which enable devices to access shared memory pools and maintain consistency across multiple endpoints. These interfaces can be used to enable memory expansion, attach accelerators like GPUs or field programmable gate arrays (FPGAs).

### BRIEF DESCRIPTION OF THE DRAWINGS

In the drawings, which are not necessarily drawn to scale, reference numerals are repeated to describe similar components in different views. Like numerals having different letter suffixes may represent different instances of similar components. The drawings illustrate generally, by way of example, but not by way of limitation, various embodiments discussed in the present document.

FIG. 1 depicts a chiplet system implementing chiplet composability, according to an embodiment.

FIG. 2 depicts component interactions in chiplet systems, according to an embodiment.

FIG. 3 depicts switch components to support chiplet composability, according to an embodiment.

FIG. 4 depicts switch mediated chiplet composition, according to an embodiment.

FIG. 5 depicts a method for chiplet composability, according to an embodiment.

FIG. 6 depicts a hardware arrangement of a data center used to provide multiple implementations or instances of a computing system, according to an example.

FIGS. 7A and 7B depict arrangements of a chip assembly with expanded views of the chiplets and processing units, according to an example.

FIG. 8 depicts a block diagram of a computing system, according to an example.

### DETAILED DESCRIPTION

With connectivity technologies, such as CXL, computer component manufacturers are expected to increase efforts to enable various composability improvements in computer systems. For example, CXL is being touted as a good basis for on-board connectivity to realize more composable systems. Such efforts seek to provide system developers tools or capabilities to design or customize systems today, using a scalable mesh for example. However, as composability grows—such as cloud growth or the integration of system components via interfaces like CXL—a growing number of systems include underutilized components that are currently inseparable from other components in the system. While consolidation has been an effective strategy (e.g., as one of the motivations of cloud) to better use such systems, often there are piecemeal components that are not so easy to consolidate.

With CXL, there is often the potential (e.g., capability) to arbitrarily hot-plug compute devices or memory via Peripheral Component Interconnect Express (PCIe) lanes within a computer. While this enables components (e.g., boards) to be added to PCIe slots in a computer, it is generally not possible to compose different compute elements at the sub-board (e.g., sub-central processing unit, near memory compute unit, etc.) level. Thus, current composability implementations are generally limited to composing systems (e.g., computers in housings, racks, etc.) in a data center of board-level components within a system connected to, for example, a central processing unit via CXL. That is, present techniques do not enable the dynamic allocation and deallocation of chiplet-level resources within devices.

The chiplet composability described herein can address the limits of static configurations at the package (e.g., device level) level in defined physical boundaries of present techniques. This chiplet composability enables addressing of a chiplet to a device external to the package of the chiplet. This external chiplet identifier can be translated into an internal chiplet identifier (e.g., address) to enable standard in-package chiplet communication to provide standard input or output functionality to the chiplet. The chiplet identifier translation can be implemented in an input-output (IO) hub of the chiplet system (e.g., within a package) to both seamlessly transfer IO from the chiplet to the external entity while also preventing internal entities (e.g., from another chiplet within the chiplet system) from communicating with the chiplet while composed with the external entity. Thus, individual chiplets in chiplet-based processors, System-on-chip (SoC) circuitry, System-in-Package (SiP) or System-on-Package (SoP) circuitry, or other modular packaging implementations of processor circuitry can be exposed and dynamically composed with other elements external to the chiplet-based processor. Additional details and examples are provided below.

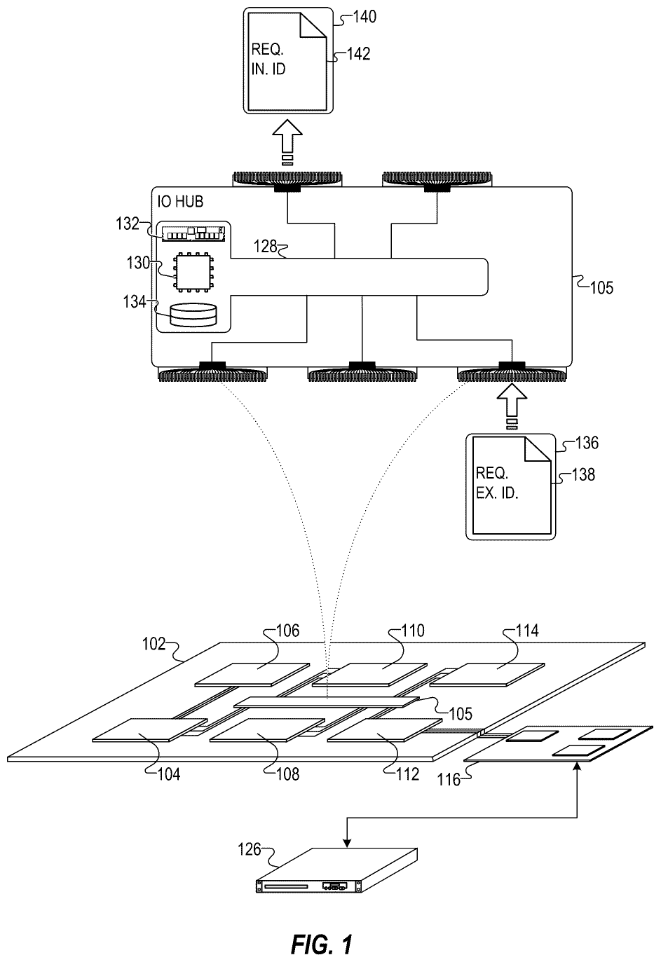

FIG. 1 depicts a chiplet system implementing chiplet composability, according to an embodiment. As illustrated, the chiplet system can include a chiplet package 102 (e.g., an SoC, SiP, SoP, chiplet assembly, etc.) that includes a compute tile 104, memory 106 (e.g., random access memory (RAM)), a data movement accelerator 108, a media or Al accelerator 110, sensor processor 114, and an off-package interface 112 (e.g., a compute express link (CXL) interface). As illustrated, the compute tile 104 is directly connected to the memory 106—such as via a double data rate (DDR) memory interface, a High Bandwidth Memory (HBM) interface, Universal Memory Interface (UMI), or Bunch of Wires (BoW) interface, etc.—the off-package interface 112 is connected to an external component 116, such as a network interface, and the remaining components communicate via an input-output (IO) hub 105 (e.g., operating in accordance with a Universal Chiplet Interconnect Express (UCIe) family of standards) of the chiplet package 102. The external component 116 can enable connectivity to other systems, such as computer system 126, in a data center or in another arrangement via a variety of networking protocols, such as an IEEE 802.3 family of standards (e.g., Ethernet) or IEEE 802.11 family of standards (e.g., WiFi) among others.

As noted above, the composability of any individual chiplet in the chiplet package can be enabled by the IO hub 105. The IO hub 105 includes processing circuitry 130, storage (e.g., a power-stable block device such as NAND flash), memory 132 (e.g., RAM, registers, etc.), chiplet interfaces, and an interconnect 128 (e.g., a bus, switch, etc.) connecting the chiplet interfaces. The storage 134 is configured to enable data to persist via power events (e.g., power off, power on, power conservation, etc.) for the IO hub 105. The memory 132 supports current state persistence of the processing circuitry 130 when in operation.

The following description of chiplet composability is provided from the perspective of the processing circuitry 130 in a composition scenario where the AI accelerator 110 is composed into the computer system 126 connected to the chiplet package 102 via the external component 116 via the off-package interface 112. Thus, the processing circuitry 130 is configured to receive a request 136 for a chiplet (e.g., the AI accelerator 110) of the chiplet package 102 that originates from an entity (e.g., the computer system 126) external to the chiplet package 102. In an example, the request is received via a platform interconnect. Here, the off-package interface 112 can implement the platform interconnect, or, in an example, the external component 116 can implement the platform interconnect. Here, platform interconnect refers to interconnects designed for in-case connectivity (e.g., such as PCIe) or near to the physical case of a computer system (e.g., Universal Serial Bus (USB)). In an example, the platform interconnect conforms to a (CXL) family of standards. In an example, the request 136 is delivered to the IO hub via a CXL switch. In an example, the external component 116 is the CXL switch.

The processing circuitry 130 is configured to translate a first identifier 138 from the request 136 into a second identifier 142 that identifies the chiplet (e.g., the AI accelerator 110) within the chiplet package 102. In an example, where the request 136 is received from a CXL platform interconnect, the first identifier 138 is a CXL apparatus designation. Several techniques can be used to perform the translation from the first identifier 138 to the second identifier 142. For example, the storage 134 can maintain a mapping from external IDs to internal IDs that are loaded into the memory 132 during runtime and references by the processing circuitry 130 when the request 136 is received. In an example, the external identifier 138 can be derived from the internal identifier 142 and another value, such as a serial number of the chiplet package 102. In this case, the external identifier 138 can be translated into the internal identifier without a mapping, but by, for example, subtracting the chiplet package serial number or via another technique. However, the translation is performed, in general, the external identifier 138 is designed to avoid collisions with other external chiplet identifiers on other chiplet packages. This type of translation is not to be confused with other, more general, types of network translation, such as Network Address Translation (NAT). That is, establishing the mapping between the first identifier and the second identifier is established prior to any request, and not in response to a request from a machine with a non-routable IP address as is common in NAT arrangements.

Once the translation from the external identifier 138 to the internal identifier 142 is complete, the processing circuitry 130 can route a version of the request 136, the internal request 140) to the chiplet via the interconnect 128 for execution at the chiplet. Thus, for example, the computer system 126, having the AI accelerator 110 composed into itself, can make the request 136 of the AI accelerator 110, which becomes the internal request 140. The AI accelerator 110 responds to the internal request 140, which is then translated from the internal identifier 142 back to the external identifier 138 if necessary (e.g., to indicate from where the response originated) and transmitted back to the computer system 126.

The flow up to this point illustrates the operation of chiplet composability after the chiplet is already part of an extra-chiplet-package system (e.g., the computer system 126). To add the chiplet to another system, or to compose the chiplet with the other system, the processing circuitry 130 is configured to receive a request from the entity (e.g., another chiplet, another SiP, etc.) to allocate the chiplet. Thus, in the illustrated scenario, the computer system 126 makes an allocation request to the chiplet package 102 (or, more specifically, to the IO hub 105) to add the AI accelerator 110 to itself.

The processing circuitry 130 is configured to proceed by updating a data structure of the IO hub 105 to map the second identifier 142 to the first identifier 138. This scenario illustrates the mapping described above. While mapping uses additional resources, such as the storage 134 or the memory 132, mapping provides great flexibility. For example, the entity can provide the first identifier 138 to the processing circuitry 130. This enables the entity to manage chiplet ID collisions on its own.

In an example, the processing circuitry 130 is configured to notify the entity that the chiplet is allocated. This is not strictly necessary in circumstances in which the entity has control of the allocation. Thus, no communication can occur unless there is an error in the allocation. However, such a confirmation that the allocation has completed successfully is often useful. In an example, the notification to the entity can include the first identifier 138. As noted above, the first identifier 138 can be derived from the second identifier 142 and an algorithm, additional data internal to the chiplet package 102, or both. In this case, or other cases in which the chiplet package assigns the first identifier 138, the notification that the chiplet is successfully allocated can include the first identifier 138.

Due to the small and possibly very numerous nature of chiplets in chiplet packages in a computer system, it can be difficult to dynamically determine which chiplets are composable and available. To address this issue, in an example, the processing circuitry 130 is configured to receive a discovery request and configured to provide a response to the discovery request indicating whether or not the chiplet is available. In an example, the response includes a time-based restriction on the availability of the chiplet. In an example, providing the response includes querying the chiplet to determine that the chiplet is available (e.g., not already allocated). This last example illustrates that the chiplet availability can be ascertained by the processing circuitry 130 in response to the discovery request. In an example, the processing circuitry 130 is configured to poll, track, or otherwise follow indications of chiplet availability and, for example, maintain a local data structure (e.g., a record) of availability in the memory 132 or the storage 134. This activity can be periodic (e.g., each second), based on an event (e.g., a message traversing the interconnect 128), or based on another trigger. In this example, the processing circuitry 130 can provide the availability of the chiplet in response to the discovery request from the local data structure without contacting the chiplet.

In an example, the processing circuitry 130 is configured to transmit (e.g., cause to the transmitted) a chiplet inventory. The chiplet inventory can include demographic information about chiplets in the chiplet package 102 to an external entity, such as a registry in a fabric, a fabric switch, or another external device. This arrangement can enable the chiplet availability, type, or other information available in a discovery response to be pre-populated and hosted by the registry or other type of external entity. Thus, for example, the computer system 126 discovers the AI accelerator 110 via the chiplet inventory hosted at a mesh orchestrator without contacting the chiplet package 102. In an example, the chiplet inventory includes identification of a set of chiplets. In an example, the identification of the set of chiplets specifies a chiplet type for included chiplets. In an example, the chiplet inventory list includes a time restriction (e.g., time period, time window, duration, etc.) of use for a chiplet in the set of chiplets. In an example, the chiplet inventory list includes a data restriction for a chiplet in the set of chiplets. For example, the chiplet can be restricted to processing data classified as not sensitive during a first shift and otherwise unavailable.

In an example, where a CXL platform interconnect is used, the processing circuitry 130 is configured to transmit (e.g., cause the transmission of) a CXL-compliant advertisement that the chiplet is available. In this case, the chiplet package 102 can actively advertise the availability of the chiplet to avoid, for example, possibly many discovery requests. In an example, the advertisement includes a platform identifier, a package identifier, a chiplet identifier, chiplet metadata, or a performance proxy. These features can enable the entity (e.g., the computer system 126) to determine whether or not the chiplet is suitable (e.g., useful, compatible, etc.) for a composed system. In an example, the CXL-compliant advertisement is transmitted to the CXL switch. Thus, the CXL switch can host the advertisement and avoid availability inquiries from burdening the chiplet package 102.

In an example, the processing circuitry 130 is configured to generate an interrupt, or other inter-chiplet package communication, in the chiplet package 102 to indicate that the chiplet is not available to the chiplet assembly. This can occur in response to an allocation or a reservation of the chiplet. Generally, once the chiplet is composed with (e.g., allocated to) an entity, that chiplet is no longer available for use with other entities, such as the other chiplets in the chiplet package 102. Such restriction is generally necessary due to the relatively simple signaling mechanisms available to chiplets as well as the often limited resources for multitasking. Thus, it is usually more appropriate to allocate and deallocate the chiplet between different entities rather than build the multi-user capabilities seen in other computing devices. In an example, the processing circuitry 130 is configured to modify a routing device (e.g., the interconnect 128) to prevent traffic from the chiplet to a second chiplet (e.g., the compute tile 104) in the chiplet package 102 and to also prevent traffic from the second chiplet to the first chiplet. By restricting communications between the chiplets of the chiplet package 102, the allocated or reserved chiplet can be effectively isolated from the other chiplets.

The examples above focused on the sharing of a chiplet in the chiplet package 102 with an external entity. However, the chiplet package 102 can also request the use of an external chiplet to augment itself. In an example, a platform interconnect facility, such as a CXL switch, can be used to manage this sharing. The chiplet package can declaratively establish the use of one or more other chiplets via a chiplet requirements list. Thus, in an example, the processing circuitry 130 is configured to transmit (e.g., cause to the transmitted) a chiplet requirement list. In an example, the chiplet requirement list includes identification of a set of chiplets. In an example, the identification of the set of chiplets specifies a chiplet type. In an example, the chiplet requirement list includes a duration of use for a chiplet in the set of chiplets. In an example, the chiplet requirement list includes a quality of service (QoS) specification for the chiplet. These requirements can be used by the interconnect platform facility to locate the requested chiplets and locate those chiplets to the chiplet package 102.

When an orchestrator or similar entity is used to manage the chiplet composability, an alternative to the allocation of the chiplet can occur, that of a reservation. In this case, the orchestrator can signal the chiplet package 102 that the chiplet is reserved (e.g., unavailable to others). This can entail separating the chiplet, as discussed below, from other chiplets in the chiplet package 102. In an example, the reservation includes a future time in which the allocation can occur. Thus, the processing circuitry 130 can continue using the chiplet until the future time and then automatically allocate the chiplet as described above.

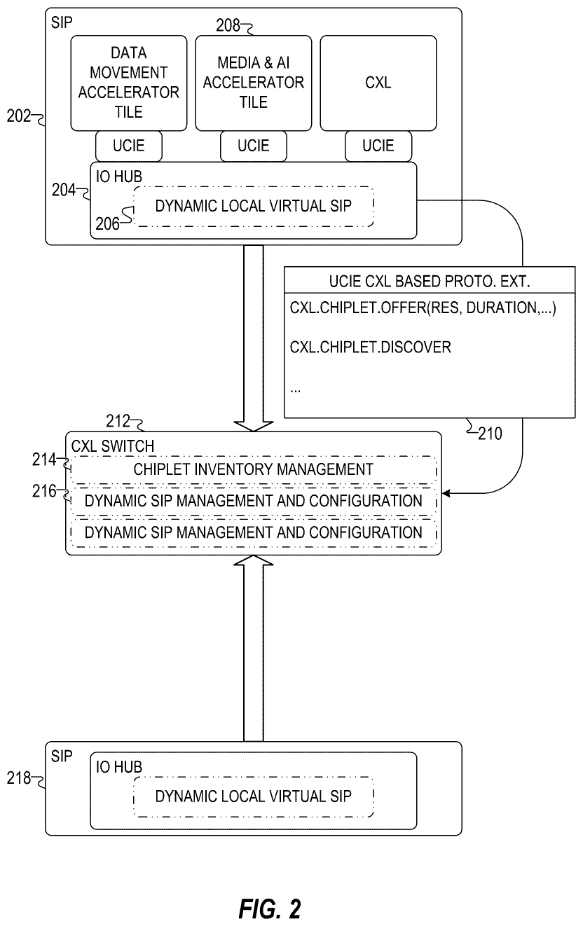

FIG. 2 depicts component interactions in chiplet systems, according to an embodiment. As illustrated, a SiP 202 is connected to another SiP 218 via a CXL switch 212. The IO hub 204 of the SiP 202 provides a virtual SiP definition 206 to the CXL switch 212 in the message 210. The virtual SiP definition 206 indicates the availability of the media & AI accelerator tile 208 for external composability. The CXL switch stores the virtual SiP definition 206 in a local copy 216, which can be used to implement CXL switch-mediated chiplet inventory management 214.

This arrangement expands current CXL architectures to provide chiplet sharing across a CXL fabric. This sharing can be dynamic, enabling opportunistic expansion of a SiP. To this end, the CXL Interconnect (e.g., protocol) is enhanced to enable entities (e.g., platforms, CPUs, etc.) to advertise chiplets that are not being used at the moment and that can be used by peers connected through the CXL switch 212. Similarly, peers can discover advertised resources and request temporal attachment of a particular chiplet to a particular SiP. This SiP temporal expansion can include latency or bandwidth requirements (e.g., restrictions) for the new SiP expanded through the CXL switch 212.

To facilitate CXL-mediated chiplet composability, chiplets (e.g., IO hubs) are configured to provide advertisements, or to answer discovery requests, to provide an indication of chiplet availability or operating requirements. Chiplets are also configured to perform allocations or bindings (e.g., translating external chiplet IDs to internal chiplet IDs or restricting access to chiplets once bound) to remote entities when required by the CXL fabric. In an example, when the allocation occurs, local chiplet traffic is routed to the remote entity (e.g., an entity external to the SiP) and becomes unavailable to the local SiP until, for example, a reclaim occurs.

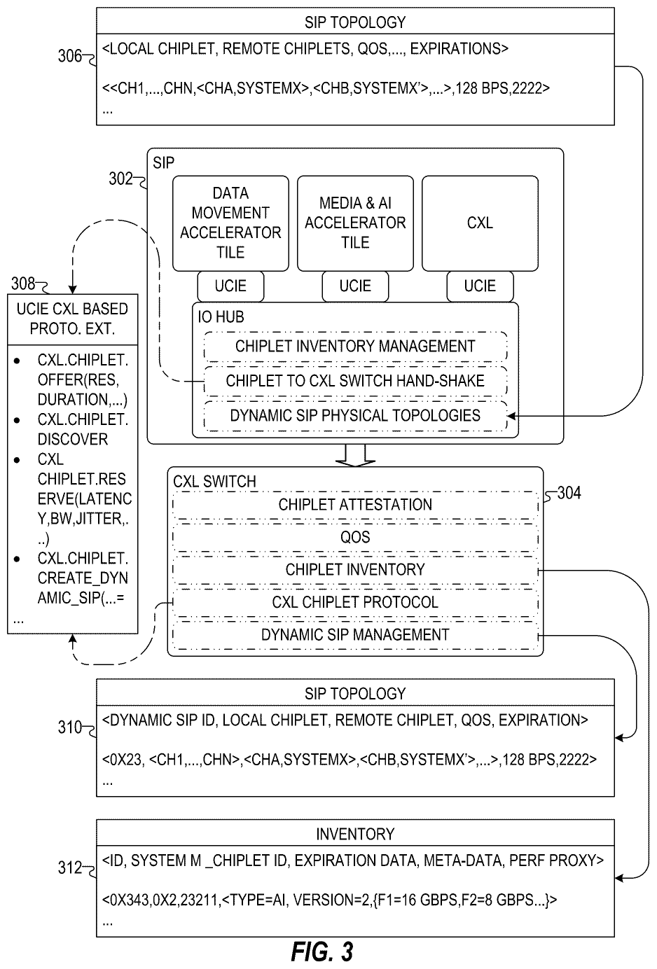

FIG. 3 depicts switch components to support chiplet composability, according to an embodiment. FIG. 3 illustrates an interaction between the SiP 302 and the CXL switch 304 to implement CXL-mediated chiplet composability across SiPs or other entities. The combination of modifications to the CXL switch 304 and the CXL attached SiP 302 can be considered an expansion upon current CXL interconnect protocols.

The SiP 302 can advertise a chiplet that may be used by other SiPs within the CXL interconnect fabric for a specified duration or until reclaimed. The parameters 308 provided to the CXL switch 304 by the SiP or platform can include the platform identifier, SiP identifier, chiplet identifier, chiplet metadata—such as type or version (e.g., type=AI, version=2.3)—or a performance proxy (e.g., data structure, summary, etc.) that represents performance metrics. The chiplet discovery process enables SiPs connected to the CXL switch 304 to identify and query available chiplets based on type, such as data movement chiplets, AI chiplets, or cryptographic chiplets.

In an example, the SiP 306 can request, or be assigned (e.g., by the CXL switch 304, a host processor, etc.) additional computational resources by borrowing (e.g., being allocated) one or more chiplets. This request can include a list of required chiplets, the duration of chiplet allocation, or quality of service constraints such as latency or bandwidth. In this example, the CXL switch 304 manages resource allocation to create a temporary expanded SiP 310. If the requested chiplets are unavailable or network resources are insufficient, the request may be denied. In an example, at any time, an SiP can reclaim a chiplet previously borrowed by another SiP. In such cases, the borrowing SiP can be configured to flush ongoing transactions within chiplet queues before releasing the chiplet.

In an example, the CXL switch 304 is configured to maintain a chiplet inventory 312, which is an active list of CXL-managed chiplets. CXL quality of service (QoS) management is configured to manage the QoS for the SiP 302 while using remote chiplets. This can include static resource allocation, where fabric resources are pre-assigned, or adaptive QoS enforcement, where enforcement is triggered based on performance metrics (e.g., network load). In these examples, CXL dynamic SiP management orchestrates the SiP expansion process. For example, the CXL fabric can instruct the chiplet owner (e.g., donating SiP) to make the chiplet unavailable locally. The routing inside the donating SiP can update configurations to reflect the new chiplet ownership. Once reconfiguration is complete, the borrowing SiP can be notified, and the chiplet is exposed as a local resource to the borrowing SiP 302.

Participating SiPs can be configured to include monitoring mechanisms to detect unused chiplets and advertise them to the CXL fabric. In an example, SiPs can be configured to provide interrupt generation when a chiplet is borrowed to notify, for example, the software stack running in the SiP that the chiplet is no longer available. In an example, the SiP is configured to reroute chiplet traffic or otherwise restrict access to locally unavailable chiplets. In an example, the SiPs include a CXL chiplet connector to expose borrowed chiplets as local chiplets and can implement a CXL.chiplet protocol. In an example, chiplet or IO hub configurations can include monitoring mechanisms for chiplet availability, interfaces for chiplet lending, or other facilities to handle interrupts or to update system configurations, to provide dynamic chiplet exposure, protocol compliance, or routing management.

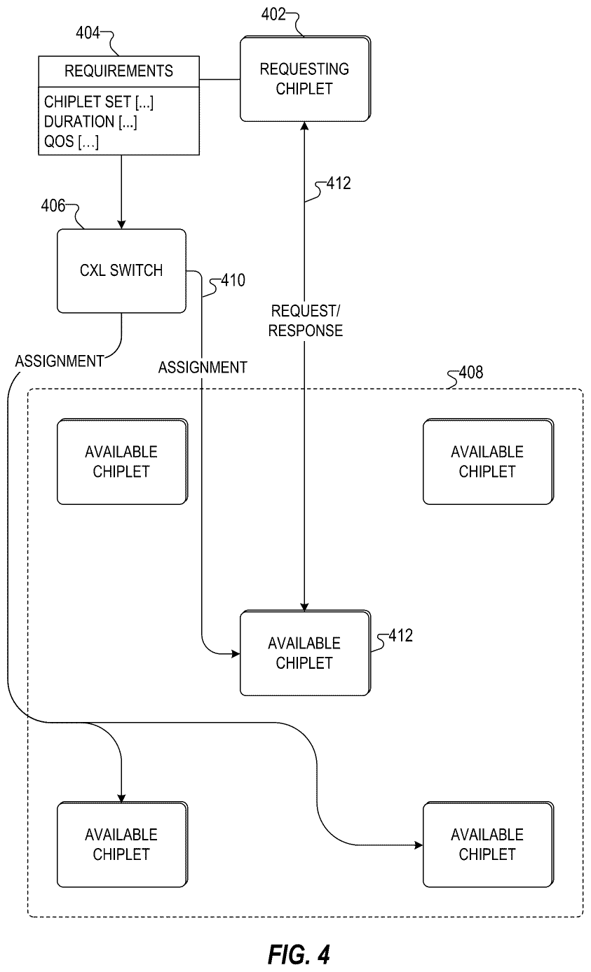

FIG. 4 depicts switch mediated chiplet composition, according to an embodiment. As illustrated, the requesting chiplet 402 is requesting composition of one or more available chiplets 408. To accomplish this, the requesting chiplet 402 creates and sends a requirements list 404 to the CXL switch 406.

Because the CXL switch 406 often operates as a hub for available chiplets in connected devices, the CXL switch 406 is well positioned to maintain records on the set of available chiplets 408, such as when the chiplets become available, what their capabilities are, etc. The CXL switch 406 can use the data in the requirements list 404 to identify which of the members of the set of available chiplets 408 can satisfy the elements of the requirements list 404.

Once the CXL switch 406 has identified a member chiplet to add to the requesting chiplet composition, the CXL switch 406 can transmit an assignment message 410 to the target chiplet 412. As noted above, the assignment message can include information, such as a new chiplet identifier or encryption keys, to enable the target chiplet 412 to participate in the hardware composition of the requesting chiplet 402. Such participation includes requests or responses 414.

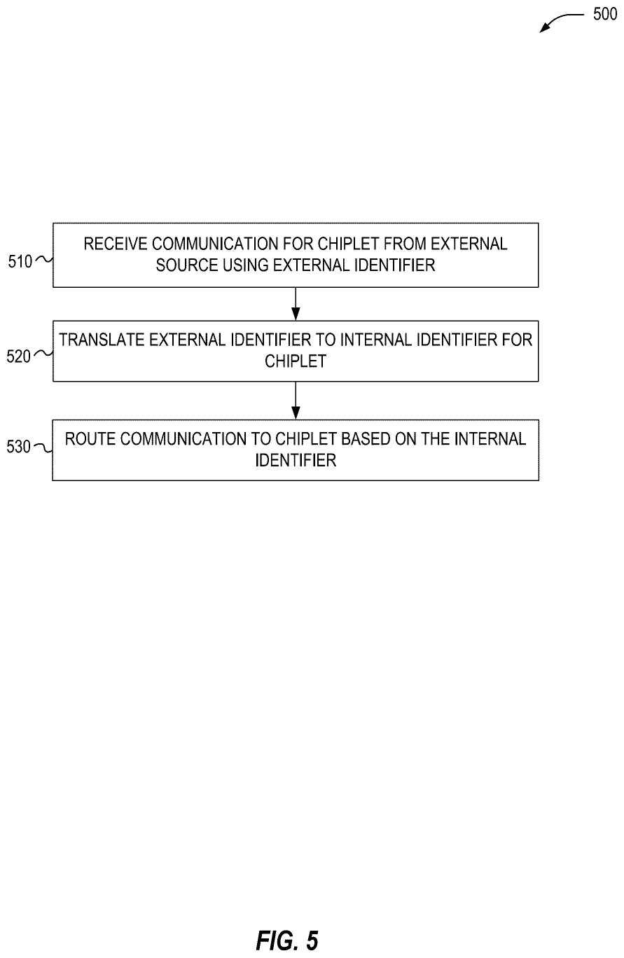

FIG. 5 depicts a method 500 for chiplet composability, according to an embodiment. The operations of the method 500 are performed by computational hardware, such as that described above or below (e.g., processing circuitry).

At operation 510, a request is received at an input-output (IO) hub of a chiplet assembly. The request is for a chiplet of the chiplet assembly and originates from an entity external to the chiplet assembly. In an example, the request is received via a platform interconnect. In an example, the platform interconnect conforms to a Computer Express Link (CXL) family of standards. In an example, the request is delivered to the IO hub via a CXL switch. In an example, the request includes the first identifier. In an example, the first identifier is an external identifier. In an example, the external identifier is a CXL apparatus designation that corresponds to a chiplet.

At operation 520, the first identifier from the request is translated into a second identifier. Here, the second identifier identifies the chiplet within the chiplet assembly. In an example, the first identifier is a CXL apparatus designation.

At operation 530, a version of the request is routed to the chiplet based on the second identifier for execution at the chiplet.

The method 500 can include the operation of receiving a request from the entity to allocate the chiplet. The method 500 can proceed with updating a data structure of the IO hub to map the second identifier to the first identifier, and then notifying the entity that the chiplet is allocated. In an example, the method 500 can include the operation of generating an interrupt in the chiplet assembly to indicate that the chiplet is not available to the chiplet assembly. In an example, the method 500 can include the operation of modifying a routing device of the IO hub to prevent traffic from the chiplet to a second chiplet in the chiplet assembly and to prevent traffic from the second chiplet to the first chiplet.

The method 500 can include the operations of receiving a discovery request and providing a response to the discovery request that the chiplet is available. In an example, the response includes a time-based restriction on availability of the chiplet. In an example, providing the response includes querying the chiplet to determine that the chiplet is available.

In an example, the querying of the chiplet is performed in response to receipt of the discovery request. In an example, the querying of the chiplet is performed periodically to update a local data structure of the IO hub to track whether or not the chiplet is available.

In an example, the operations of the method 500 can include transmitting a Compute Express Link (CXL) compliant advertisement that the chiplet is available. In an example, the advertisement includes a platform identifier, a package identifier, a chiplet identifier, chiplet metadata, or a performance proxy. In an example, the CXL-compliant advertisement is transmitted to a CXL switch coupled to the IO hub during operation.

In an example, the operations of the method 500 can include transmitting, to an external device in a fabric, a chiplet requirement list. In an example, the chiplet requirement list includes identification of a set of chiplets. In an example, the identification of the set of chiplets specifies a chiplet type. In an example, the chiplet requirement list includes a duration of use for a chiplet in the set of chiplets. In an example, the chiplet requirement list includes a quality of service (QoS) specification for the chiplet. In an example, the operations of the method 500 include receiving an identification for the chiplet and transmitting a reservation for the chiplet.

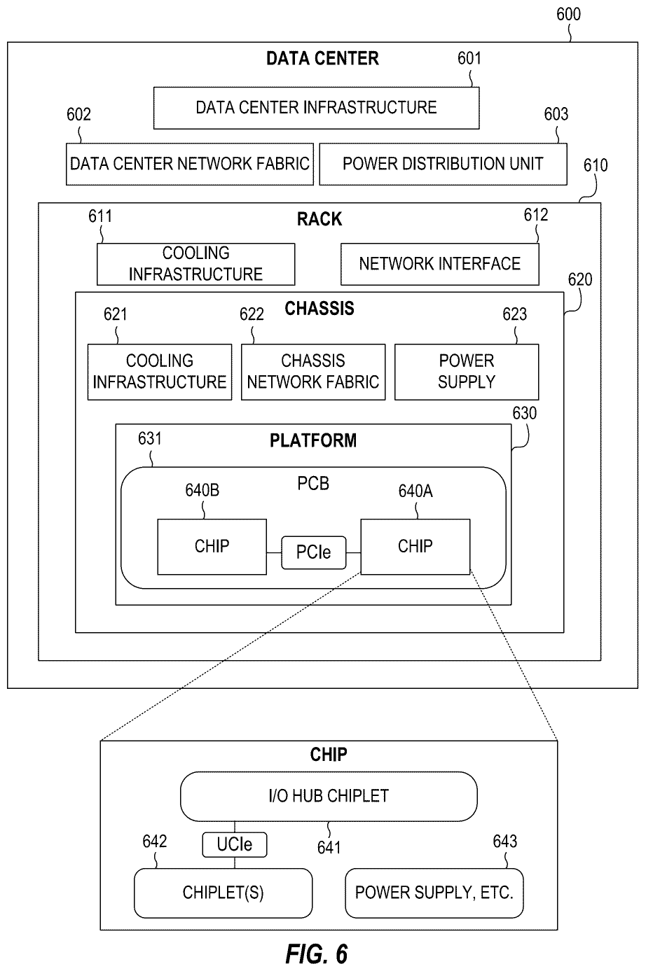

FIGS. 6, 7A, 7B, and 8 respectively depict simplified aspects of example computing architectures in which any of the techniques and configurations above may be implemented. It will be understood that the elements described above for chiplet composability may be integrated into various forms of the following hardware components.

FIG. 6 depicts an example hardware arrangement of a data center 600 used to provide multiple implementations or instances of a computing system (e.g., computing system 800, discussed below), with each instance of the computing system being identified as a respective platform (e.g., platform 630). The data center 600 includes data center infrastructure 601, a data center network fabric 602, and a power distribution unit 603 to support multiple racks of compute platforms, with a single instance of a rack 610 depicted. The data center infrastructure 601 may provide physical components that host the compute platform hardware, storage components, and networking equipment; the data center network fabric 602 may include switches and networking components to support data flows among various compute platforms and storage devices throughout the data center; and the power distribution unit 603 may include components to distribute and control power among the various compute platforms, networking, and storage devices.

The rack 610 includes but is not limited to cooling infrastructure 611, a network interface 612, and related physical components (not shown) to support discrete instances of multiple chassis. The rack 610 provides power, connectivity, and cooling to each of the multiple chassis in a single rack, with a single instance of a chassis 620 depicted in FIG. 6. The chassis 620 includes but is not limited to cooling infrastructure 621, a chassis network fabric 622, and a power supply 623, which provides cooling, network connectivity, and power to multiple platforms within the chassis, with a single instance of a platform 630 depicted in FIG. 6. It will be understood that a common data center rack configuration may include dozens of chassis, with each chassis adapted to support a number of platforms depending on the physical size of the platform hardware and supporting equipment.

The platform 630 in some implementations may be referred to as a server or node, depending on the use case for the platform 630 and the data center 600. The platform 630 includes but is not limited to implementations of a discrete computing system hosted on a single board. The platform 630 is depicted as hosting a chip assembly 640A and chip assembly 640B on a first board provided by a printed circuitry board (PCB) or other platform board, shown as PCB 631. In some examples, the platform 630 may include only one chip package, whereas the PCB 631 depicts interconnection of multiple chip assemblies via a device-to-device interface (e.g., a PCI express (PCIe) or compute express link (CXL) interface). Additional chip packages and components (not shown) may also be hosted on the PCB 631.

Some implementations of the chip assembly 640A and 640B may be termed as a System-on-Chip (SoC) package, as modular chiplets that perform different functions are integrated into a single package—even though this chip package is composed of multiple dies, unlike a traditional SoC design that uses a single die. Other implementations of the chip assembly 640A and 640B may be termed as a System-on-Package (SoP), System-in-a-Package (SiP), or similar references to a single chip package. Various combinations of 2D, 2.5D, and 3D packaging technologies may be used to manufacture and assemble the chip package and its underlying structure, and different manufacturing processes may be used to provide chiplets and components from different process nodes (e.g., semiconductor fabrication systems).

The chip assembly 640A and chip assembly 640B are each packages that include multiple chiplets or dies for respective functions, such as separate chiplets for processing (e.g., CPU or GPU chiplets), memory (e.g., cache or high-bandwidth memory chiplets), I/O (e.g., I/O chiplets), acceleration (e.g., AI/ML acceleration chiplets), signal processing (e.g., audio or video processing chiplets), and the like. A close-up of chip assembly 640A is depicted as including an I/O Hub chiplet 641, chiplets 642, and a power supply 643. These components may be hosted on an interposer that is designed to connect multiple dies or components within a single semiconductor package (e.g., chip package). In some examples, the chiplets 642 may be manufactured and sourced separately and later assembled into the chip package to create the chip assembly 640A. Various connections may be provided among the chiplets 642 such as with the use of Universal Chiplet Interconnect Express (UCIe) or similar chiplet-to-chiplet interfaces and interconnects (e.g., Advanced Interface Bus (AIB), Bunch of Wires (BoW), etc.), or between chiplets and on-chip memory (e.g., high-bandwidth memory (HBM)) using HBM3 (JEDEC), Universal Memory Interface (UMI), or other memory interfaces. Similar interfaces and interconnects may be used for chip-to-chip or die-to-die communications (e.g., using NVIDIA® NVLink-C2C, Cache Coherent Interconnect for Accelerators (CIX), Compute Express Link (CXL), Advanced extensible Interface (AXI), and certain implementations of PCIe, CXL, etc.).

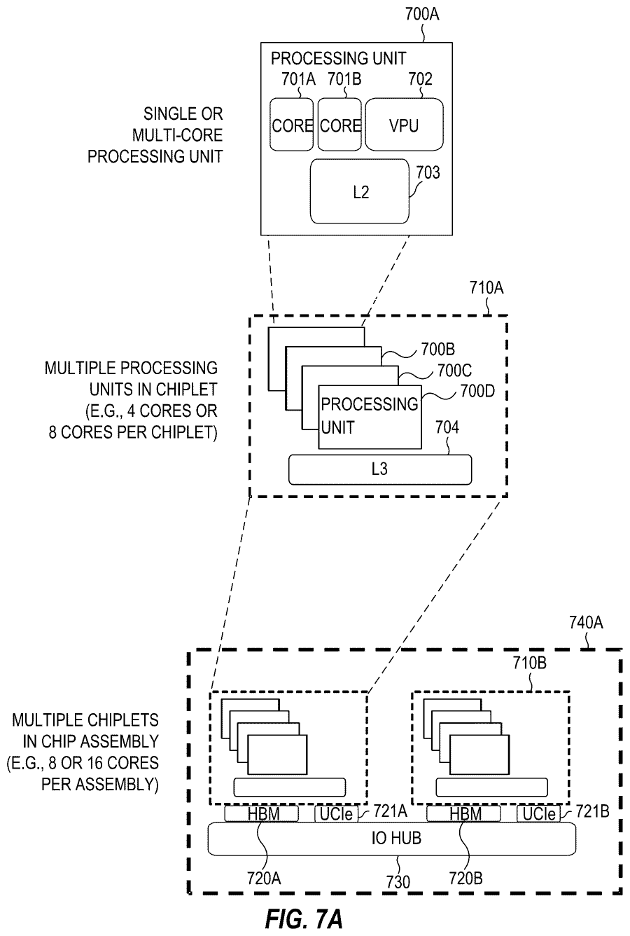

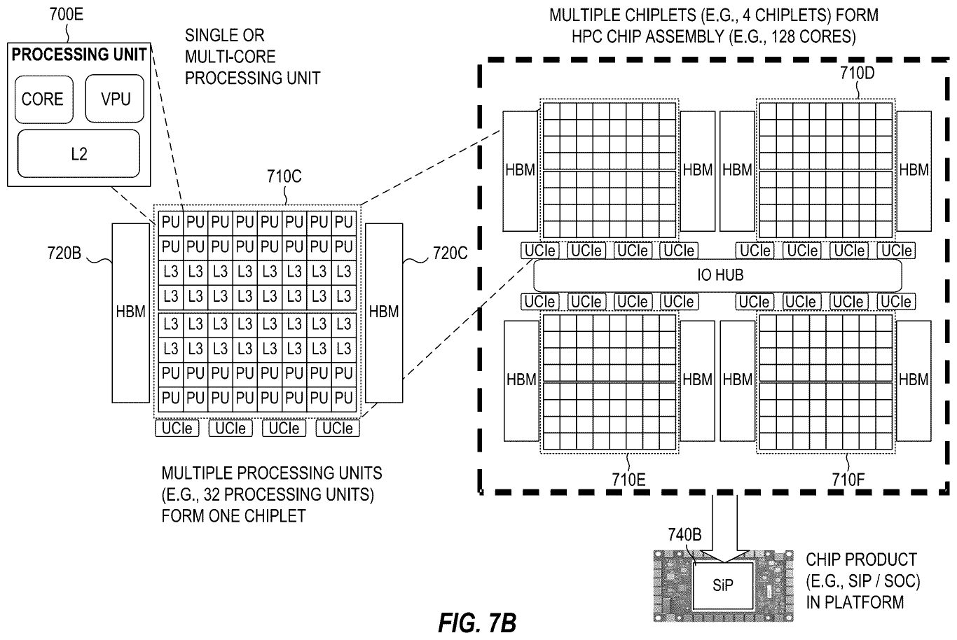

FIG. 7A depicts an example arrangement of a chip assembly 740A (e.g., a multi-processing core implementation of chip assembly 640A or 640B), with expanded views of the chiplets and processing units included therein. This arrangement shows how the chip assembly 740A, which may constitute a SoC, SoP, SiP, or other type of chip package, is composed from chiplets such as chiplet 710A, chiplet 710B, etc. and associated on-package memory (e.g., high-speed memory) such as 3D-stacked, HBM instances shown as HBM 720A, HBM 720B, interfaces (e.g., UCIe interfaces) shown as UCIe 721A, UCIe 721B, and I/O hub 730 (e.g., which may be implemented by a I/O chiplet). Other hardware elements of a chip package are not depicted for simplicity.

Each chiplet includes multiple processing units, and each processing unit includes one or multiple cores. For instance, chiplet 710A, as depicted, includes four processing units (processing unit 700A, processing unit 700B, processing unit 700C, and processing unit 700D) and an L3 cache 704. Each processing unit may include one or multiple processing cores, one or multiple caches, and, optionally, other processing units or elements. For instance, processing unit 700A is depicted as including two cores (core 701A and core 701B), vector processing unit 702, and an L2 cache 703. Accordingly, a single-core processing unit arrangement can provide 4 cores per chiplet and 8 total cores in a two-chiplet chip assembly, whereas a dual-core processing unit arrangement can provide 8 cores per chiplet and 16 total cores in a two-chiplet chip assembly. Other permutations may also be provided. A variety of signaling interfaces and protocols (not shown) may be used for core-to-core and inter-processor communications, including but not limited to the use of coherency protocols, mesh, ring, or hybrid ring-mesh interconnects, Network-on-Chip (NoC), and packet-switched communications and the like.

FIG. 7B depicts an example arrangement of a chip assembly 740B (e.g., a multi-chiplet high-performance computing (HPC) implementation of chip assembly 640A, 640B), adapted for HPC applications (e.g., parallel processing operations involving thousands, millions, or more of processors or cores operating simultaneously). The example chip assembly 740B depicts placement as a SiP, SoC, or other package onto a platform board (e.g., PCB 631), and optionally in a data center (e.g., data center 600) or in a standalone deployment setting (e.g., in a standalone computer system, mobile computing device, autonomous device, etc.).

The chip assembly 740B is composed of multiple chiplets, shown with four chiplets: chiplet 710C, chiplet 710D, chiplet 710E, chiplet 710F. Each chiplet includes multiple processing units, such as 32 processing units with a corresponding L3 cache for each processing unit. Each processing unit may include one or multiple cores, such as a single-core processing unit 700E shown as part of chiplet 710C. The chip assembly 740B is also composed of corresponding memory resources, such as HBM elements corresponding to respective banks of processing units (e.g., HBM 720B and HBM 720C corresponding respective sets of processing units of chiplet 710C), UCIe interfaces, and an IO Hub.

The chip assembly and related products or devices described herein may be configured in a variety of computing system implementations. Such implementations include machine-readable non-transitory media storing machine-readable instructions and one or more processors coupled to the memory, such that executing the machine-readable instructions configures the computing system and implementing hardware (e.g., the processing unit 700, chiplet 710, chip 640, platform 630) to perform steps and operations described above for electronic systems or devices (e.g., to perform chiplet composability, etc.). It should be further understood that software including one or more computer-executable instructions that facilitate processing and operations as described above may be distributed, installed, or otherwise provided with networked devices (e.g., servers or cloud computing systems). Alternatively, in some examples, the software may be obtained and loaded (or re-loaded/upgraded) from one or more servers and/or cloud computing systems, such as software stored on a server for distribution over the Internet, for example.

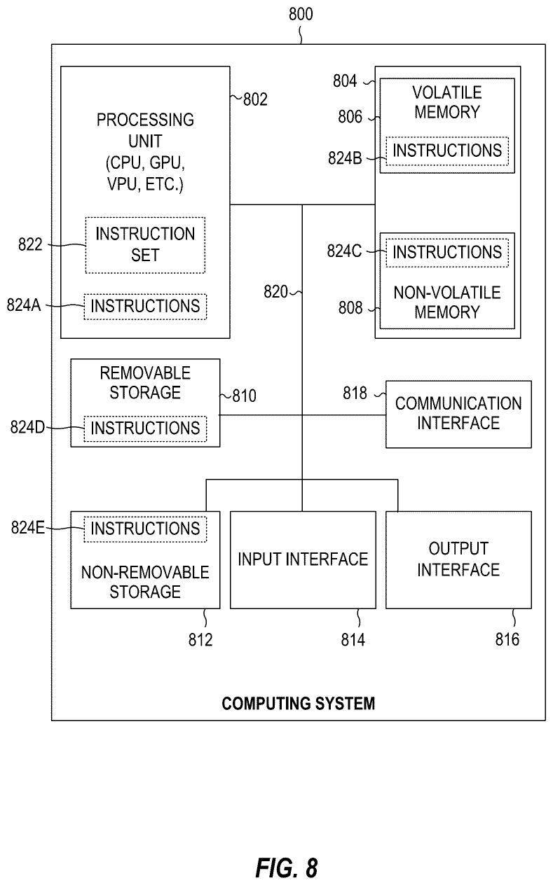

FIG. 8 depicts a block diagram of an example computing system 800 (e.g., device, apparatus, machine, etc.) that may be programmed into a special purpose machine suitable for implementing one or more embodiments for chiplet composability and like aspects disclosed herein. For instance, the chiplets, interconnect platforms, or other components described above may be embodied by the computing system 800, such as in the form of a computer or specialized electronic device that includes sufficient processing power, memory resources, and communications throughput capability to perform operations consistent with the examples herein.

The computing system 800 may include at least one hardware processing unit 802, such as a central processing unit (CPU), a graphics processing unit (GPU), a vector processing unit (VPU), a neural processing unit (NPU), a hardware accelerator, or combinations or variants thereof. The at least one hardware processing unit 802 is an implementation of processor circuitry and may be embodied by various types of chip assemblies, products, or packages as discussed with reference to FIGS. 6 to 7B. Circuitry (e.g., processing circuitry), as used herein, is a collection of circuits implemented in tangible entities of the computing system 800 that include hardware (e.g., simple circuits, gates, logic, etc.). Circuitry membership may be flexible over time. Circuitries include members that may, alone or in combination, perform specified operations when operating. In some examples, hardware of the circuitry may be immutably designed to carry out a specific operation (e.g., hardwired).

In an example, the hardware of the circuitry may include variably connected physical components (e.g., execution units, transistors, simple circuits, etc.), including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the machine-readable medium elements can be part of the circuitry or communicatively coupled to the other components of the circuitry when the device is operating. Also, in some examples, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The computing system 800 may also include at least one memory device 804 such as volatile memory 806 and non-volatile memory 808, and at least one storage device, such as removable storage 810 and/or non-removable storage 812 such as a drive unit, some or all of which may communicate with each other via an interconnect, fabric, link, or bus 820.

The computing system 800 may include an output interface 816, such as an interface connected to a display device, and an input interface 814, such as an interface connected to an alphanumeric input device or a user interface (UI) navigation device. In some examples, a connected I/O device may also include a display device, an alphanumeric input device, and a navigation device that is integrated into a single unit, such as a touch screen display.

The computing system 800 may additionally include a communication interface 818, such as for connection with a network interface device used to transmit and receive electronic signals on a network. The computing system 800 may also include other interfaces or hardware (not shown) in connection with a signal generation device (e.g., an audio or radio signal generation device), an output controller (e.g., for connection with a serial, universal serial bus (USB), parallel, or other wired or wireless connection such as which uses via infrared (IR) or near field communication (NFC) technologies), an input controller (e.g., for connection with sensors or peripheral devices), and the like.

Any of the memory or storage devices, such as the volatile memory 806, the non-volatile memory 808, the removable storage 810, or the non-removable storage 812 may provide a machine-readable medium. Some examples of a machine-readable medium are a non-transitory medium that hosts or stores one or more sets of data structures or instructions (e.g., software instructions) embodying or utilized by any one or more of the techniques or functions described herein. Such instructions are collectively labeled as instructions 824 with respective implementations of instructions 824A, 824B, 824C, 824D, and 824E.

The instructions 824 may reside, during execution or other operation of the computing system 800, completely or at least partially within the volatile memory 806 as instructions 824B, within non-volatile memory 808 as instructions 824C, within removable storage as instructions 824D, within non-removable storage as instructions 824E, or within the hardware processing unit 802 as instructions 824A. Thus, any combination of the hardware processing unit 802, the volatile memory 806, the non-volatile memory 808, or a storage device of the removable storage 810 or non-removable storage 812 may constitute a machine-readable medium or media. The instructions 824A, when loaded and executed by the hardware processing unit 802, may invoke or utilize a defined instruction set 822 of the hardware processing unit 802, such as a processor instruction set defined by an instruction set architecture (ISA) of a reduced instruction set computer (RISC) or complex instruction set computer (CISC) architecture—including but not limited to the RISC-V Instruction Set provided in a RISC-V architecture. It will be understood that a RISC-V architecture and instruction set is one of several available architectures and instruction sets that may be used in implementations of the functional compute components (e.g., the hardware processing unit 802) discussed herein.

The term “machine-readable medium” may include any medium that is capable of storing, encoding, or carrying instructions for execution by components or the whole of the computing system 800 (or a similar machine), and that cause the computing system 800 or its components to perform any one or more of the techniques or functions described herein, or that is capable of storing, encoding, or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; and optical or magneto-optical disks.

The instructions 824 may further be transmitted or received over a communications network using a transmission medium via the communication interface 818 and related devices utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®), IEEE 802.15.4 family of standards, peer-to-peer (P2P) networks, among others.

Method examples or other operations described herein can be implemented in part or in whole by the aforementioned machines, platforms, devices, or related systems (including computer, robotic, and autonomous systems). The components of the illustrative devices, systems, and methods employed may be implemented in various examples by digital electronic circuitry, analog electronic circuitry, or in computer hardware, firmware, software, or in combinations of them. These components may be implemented, for example, as a computing program product such as a computing program, program code, or computer instructions tangibly embodied in an information carrier, or in a machine-readable storage device, for execution by, or to control the operation of, a data processing apparatus such as a programmable processor, a computer, or multiple computers.

A computing program may be written in any form of programming language, including compiled or interpreted languages, and it may be deployed in any form, including as a stand-alone program or as a module, component, subroutine, or other unit suitable for use in a computing environment. Also, functional programs, codes, and code segments for accomplishing the techniques described herein may be easily construed as within the scope of the present disclosure by programmers skilled in the art.

Method steps associated with the illustrative embodiments may be performed by processing circuitry executing a computing program, code, or instructions to perform operations or functions (e.g., by operating on input data and/or generating an output). Further, such operations or functions may be embodied by a machine-readable medium, which is capable of storing instructions for execution by processing circuitry (including the specific processing unit examples discussed herein), such that the instructions, when executed by the processing circuitry, cause the processing circuitry to perform any one or more of the methodologies described herein.

In broad strokes this application describes devices, systems, and techniques for chiplet composability using a communication device (e.g., input-output hub, switch, etc.) within a chiplet assembly that facilitates external requests for chiplet allocation, discovery, and execution (e.g., using Compute Express Link (CXL) standards). The communication device can receive requests, translate identifiers to locate specific chiplets, and route requests accordingly. The communication device can support chiplet allocation by updating internal mappings, generating interrupts, or modifying routing to isolate allocated chiplets. Discovery mechanisms can enable querying chiplet availability, responding with time-based restrictions, or transmitting CXL-compliant advertisements. Chiplet requirements can be communicated to an external device (e.g., a CXL switch), specifying chiplet type, usage duration, or quality of service (QoS) needs, to enable the external device to perform dynamic chiplet reservation or resource sharing across a fabric.

Additional examples of the presently described embodiments include the following non-limiting implementations. Each of the following non-limiting examples may stand on its own or may be combined in any permutation or combination with any one or more of the other examples provided below or throughout the present disclosure.

Example 1 is an apparatus for chiplet composability, the apparatus comprising: a set of interfaces configured to receive a request for a chiplet of a chiplet assembly, the request arriving from an entity external to the chiplet assembly, the apparatus being part of an input-output (IO) hub of a chiplet assembly; and processing circuitry configured to: translate a first identifier from the request into a second identifier, the second identifier identifying the chiplet within the chiplet assembly; and route a version of the request to the chiplet based on the second identifier for execution at the chiplet.

In Example 2, the subject matter of Example 1, wherein the request is received via a platform interconnect.

In Example 3, the subject matter of Example 2, wherein the platform interconnect conforms to a Computer Express Link (CXL) family of standards.

In Example 4, the subject matter of Example 3, wherein the request is delivered to the set of interfaces via a CXL switch.

In Example 5, the subject matter of any of Examples 3-4, wherein the request includes a CXL apparatus designation that corresponds to a chiplet.

In Example 6, the subject matter of any of Examples 1-5, wherein the set of interfaces is configured to receive a request from the entity to allocate the chiplet, and wherein the processing circuitry is configured to: update a data structure of the apparatus to map the second identifier to the first identifier; and notify the entity that the chiplet is allocated.

In Example 7, the subject matter of Example 6, wherein the processing circuitry is configured to generate an interrupt in the chiplet assembly to indicate that the chiplet is not available to the chiplet assembly.

In Example 8, the subject matter of any of Examples 6-7, wherein the processing circuitry is configured to modify a routing device of the apparatus to prevent traffic from the chiplet to a second chiplet in the chiplet assembly and to prevent traffic from the second chiplet to the chiplet.

In Example 9, the subject matter of any of Examples 6-8, wherein the set of interfaces is configured to receive a discovery request, and wherein the processing circuitry is configured to provide a response to the discovery request that the chiplet is available.

In Example 10, the subject matter of Example 9, wherein the response includes a time-based restriction on availability of the chiplet.

In Example 11, the subject matter of any of Examples 9-10, wherein, to provide the response, the processing circuitry is configured to query the chiplet to determine that the chiplet is available.

In Example 12, the subject matter of Example 11, wherein the processing circuitry is configured to query querying the chiplet in response to receipt of the discovery request.

In Example 13, the subject matter of Example 12, wherein the processing circuitry is configured to query the chiplet periodically to update a local data structure of the apparatus to track whether or not the chiplet is available.

In Example 14, the subject matter of any of Examples 6-13, wherein the processing circuitry is configured to transmit a Compute Express Link (CXL) compliant advertisement that the chiplet is available.

In Example 15, the subject matter of Example 14, wherein the CXL-compliant advertisement includes a platform identifier, a package identifier, a chiplet identifier, chiplet metadata, or a performance proxy.

In Example 16, the subject matter of any of Examples 14-15, wherein the CXL-compliant advertisement is transmitted to a CXL switch coupled to the apparatus during operation.

In Example 17, the subject matter of any of Examples 1-16, wherein the processing circuitry is configured to transmit, to an external device in a fabric, a chiplet requirement list.

In Example 18, the subject matter of Example 17, wherein the chiplet requirement list includes: identification of a set of chiplets; a duration of use for a chiplet in the set of chiplets; and a quality of service (QoS) specification for the chiplet.

In Example 19, the subject matter of Example 18, wherein the identification of the set of chiplets specifies a chiplet type for the chiplet in the set of chiplets.

In Example 20, the subject matter of any of Examples 17-19, wherein the set of interfaces is configured to receive an identification for the chiplet, and wherein the processing circuitry is configured to transmit a reservation for the chiplet.

Example 21 is a method for chiplet composability, the method comprising: receiving, at an input-output (IO) hub of a chiplet assembly, a request for a chiplet of the chiplet assembly, the request arriving from an entity external to the chiplet assembly; translating a first identifier from the request into a second identifier, the second identifier identifying the chiplet within the chiplet assembly; and routing a version of the request to the chiplet based on the second identifier for execution at the chiplet.

In Example 22, the subject matter of Example 21, wherein the request is received via a platform interconnect.

In Example 23, the subject matter of Example 22, wherein the platform interconnect conforms to a Computer Express Link (CXL) family of standards.

In Example 24, the subject matter of Example 23, wherein the request is delivered to the IO hub via a CXL switch.

In Example 25, the subject matter of any of Examples 23-24, wherein the request includes a CXL apparatus designation that corresponds to a chiplet.

In Example 26, the subject matter of any of Examples 21-25, comprising: receiving a request from the entity to allocate the chiplet; updating a data structure of the IO hub to map the second identifier to the first identifier; and notifying the entity that the chiplet is allocated.

In Example 27, the subject matter of Example 26, comprising generating an interrupt in the chiplet assembly to indicate that the chiplet is not available to the chiplet assembly.

In Example 28, the subject matter of any of Examples 26-27, comprising modifying a routing device of the IO hub to prevent traffic from the chiplet to a second chiplet in the chiplet assembly and to prevent traffic from the second chiplet to the chiplet.

In Example 29, the subject matter of any of Examples 26-28, comprising: receiving a discovery request; and providing a response to the discovery request that the chiplet is available.

In Example 30, the subject matter of Example 29, wherein the response includes a time-based restriction on availability of the chiplet.

In Example 31, the subject matter of any of Examples 29-30, wherein providing the response includes querying the chiplet to determine that the chiplet is available.

In Example 32, the subject matter of Example 31, wherein the querying of the chiplet is in response to receipt of the discovery request.

In Example 33, the subject matter of Example 32, wherein the querying of the chiplet is performed periodically to update a local data structure of the IO hub to track whether or not the chiplet is available.

In Example 34, the subject matter of any of Examples 26-33, comprising transmitting a Compute Express Link (CXL) compliant advertisement that the chiplet is available.

In Example 35, the subject matter of Example 34, wherein the CXL-compliant advertisement includes a platform identifier, a package identifier, a chiplet identifier, chiplet metadata, or a performance proxy.

In Example 36, the subject matter of any of Examples 34-35, wherein the CXL-compliant advertisement is transmitted to a CXL switch coupled to the IO hub during operation.

In Example 37, the subject matter of any of Examples 21-36, comprising transmitting, to an external device in a fabric, a chiplet requirement list.

In Example 38, the subject matter of Example 37, wherein the chiplet requirement list includes: identification of a set of chiplets; a duration of use for a chiplet in the set of chiplets; and a quality of service (QoS) specification for the chiplet.

In Example 39, the subject matter of Example 38, wherein the identification of the set of chiplets specifies a chiplet type for the chiplet in the set of chiplets.

In Example 40, the subject matter of any of Examples 37-39, comprising: receiving an identification for the chiplet; and transmitting a reservation for the chiplet.

Example 41 is a machine-readable media including instructions for chiplet composability, the instructions, when executed by processing circuitry, cause the processing circuitry to perform operation comprising: receiving, at an input-output (IO) hub of a chiplet assembly, a request for a chiplet of the chiplet assembly, the request arriving from an entity external to the chiplet assembly; translating a first identifier from the request into a second identifier, the second identifier identifying the chiplet within the chiplet assembly; and routing a version of the request to the chiplet based on the second identifier for execution at the chiplet.

In Example 42, the subject matter of Example 41, wherein the request is received via a platform interconnect.

In Example 43, the subject matter of Example 42, wherein the platform interconnect conforms to a Computer Express Link (CXL) family of standards.

In Example 44, the subject matter of Example 43, wherein the request is delivered to the IO hub via a CXL switch.

In Example 45, the subject matter of any of Examples 43-44, wherein the request includes a CXL apparatus designation that corresponds to a chiplet.

In Example 46, the subject matter of any of Examples 41-45, wherein the operations comprise: receiving a request from the entity to allocate the chiplet; updating a data structure of the IO hub to map the second identifier to the first identifier; and notifying the entity that the chiplet is allocated.

In Example 47, the subject matter of Example 46, wherein the operations comprise generating an interrupt in the chiplet assembly to indicate that the chiplet is not available to the chiplet assembly.

In Example 48, the subject matter of any of Examples 46-47, wherein the operations comprise modifying a routing device of the IO hub to prevent traffic from the chiplet to a second chiplet in the chiplet assembly and to prevent traffic from the second chiplet to the chiplet.

In Example 49, the subject matter of any of Examples 46-48, wherein the operations comprise: receiving a discovery request; and providing a response to the discovery request that the chiplet is available.

In Example 50, the subject matter of Example 49, wherein the response includes a time-based restriction on availability of the chiplet.

In Example 51, the subject matter of any of Examples 49-50, wherein providing the response includes querying the chiplet to determine that the chiplet is available.

In Example 52, the subject matter of Example 51, wherein the querying of the chiplet is in response to receipt of the discovery request.

In Example 53, the subject matter of Example 52, wherein the querying of the chiplet is performed periodically to update a local data structure of the IO hub to track whether or not the chiplet is available.

In Example 54, the subject matter of any of Examples 46-53, wherein the operations comprise transmitting a Compute Express Link (CXL) compliant advertisement that the chiplet is available.

In Example 55, the subject matter of Example 54, wherein the CXL-compliant advertisement includes a platform identifier, a package identifier, a chiplet identifier, chiplet metadata, or a performance proxy.

In Example 56, the subject matter of any of Examples 54-55, wherein the CXL-compliant advertisement is transmitted to a CXL switch coupled to the IO hub during operation.

In Example 57, the subject matter of any of Examples 41-56, wherein the operations comprise transmitting, to an external device in a fabric, a chiplet requirement list.

In Example 58, the subject matter of Example 57, wherein the chiplet requirement list includes: identification of a set of chiplets; a duration of use for a chiplet in the set of chiplets; and a quality of service (QoS) specification for the chiplet.

In Example 59, the subject matter of Example 58, wherein the identification of the set of chiplets specifies a chiplet type for the chiplet in the set of chiplets.

In Example 60, the subject matter of any of Examples 57-59, wherein the operations comprise: receiving an identification for the chiplet; and transmitting a reservation for the chiplet.

Example 61 is a system for chiplet composability, the system comprising: means for receiving, at an input-output (IO) hub of a chiplet assembly, a request for a chiplet of the chiplet assembly, the request arriving from an entity external to the chiplet assembly; means for translating a first identifier from the request into a second identifier, the second identifier identifying the chiplet within the chiplet assembly; and means for routing a version of the request to the chiplet based on the second identifier for execution at the chiplet.

In Example 62, the subject matter of Example 61, wherein the request is received via a platform interconnect.

In Example 63, the subject matter of Example 62, wherein the platform interconnect conforms to a Computer Express Link (CXL) family of standards.

In Example 64, the subject matter of Example 63, wherein the request is delivered to the IO hub via a CXL switch.

In Example 65, the subject matter of any of Examples 63-64, wherein the request includes a CXL apparatus designation that corresponds to a chiplet.

In Example 66, the subject matter of any of Examples 61-65, comprising: means for receiving a request from the entity to allocate the chiplet; means for updating a data structure of the IO hub to map the second identifier to the first identifier; and means for notifying the entity that the chiplet is allocated.

In Example 67, the subject matter of Example 66, comprising means for generating an interrupt in the chiplet assembly to indicate that the chiplet is not available to the chiplet assembly.

In Example 68, the subject matter of any of Examples 66-67, comprising means for modifying a routing device of the IO hub to prevent traffic from the chiplet to a second chiplet in the chiplet assembly and to prevent traffic from the second chiplet to the chiplet.

In Example 69, the subject matter of any of Examples 66-68, comprising: means for receiving a discovery request; and means for providing a response to the discovery request that the chiplet is available.

In Example 70, the subject matter of Example 69, wherein the response includes a time-based restriction on availability of the chiplet.

In Example 71, the subject matter of any of Examples 69-70, wherein the means for providing the response include means for querying the chiplet to determine that the chiplet is available.

In Example 72, the subject matter of Example 71, wherein the querying of the chiplet is in response to receipt of the discovery request.

In Example 73, the subject matter of Example 72, wherein the querying of the chiplet is performed periodically to update a local data structure of the IO hub to track whether or not the chiplet is available.

In Example 74, the subject matter of any of Examples 66-73, comprising means for transmitting a Compute Express Link (CXL) compliant advertisement that the chiplet is available.

In Example 75, the subject matter of Example 74, wherein the CXL-compliant advertisement includes a platform identifier, a package identifier, a chiplet identifier, chiplet metadata, or a performance proxy.

In Example 76, the subject matter of any of Examples 74-75, wherein the CXL-compliant advertisement is transmitted to a CXL switch coupled to the IO hub during operation.

In Example 77, the subject matter of any of Examples 61-76, comprising means for transmitting, to an external device in a fabric, a chiplet requirement list.

In Example 78, the subject matter of Example 77, wherein the chiplet requirement list includes: identification of a set of chiplets; a duration of use for a chiplet in the set of chiplets; and a quality of service (QoS) specification for the chiplet.

In Example 79, the subject matter of Example 78, wherein the identification of the set of chiplets specifies a chiplet type for the chiplet in the set of chiplets.

In Example 80, the subject matter of any of Examples 77-79, comprising: means for receiving an identification for the chiplet; and means for transmitting a reservation for the chiplet.

Example 81 is at least one machine-readable medium including

instructions that, when executed by processing circuitry, cause the processing circuitry to perform operations to implement of any of Examples 1-80.

Example 82 is an apparatus comprising means to implement of any of Examples 1-80.

Example 83 is a system to implement of any of Examples 1-80.

Example 84 is a method to implement of any of Examples 1-80.

What is claimed is:

1. An apparatus for chiplet composability, the apparatus comprising:
a set of interfaces configured to receive a request for a chiplet of a chiplet assembly, the request from an entity external to the chiplet assembly, the apparatus being part of an input-output (IO) hub of a chiplet assembly; and
processing circuitry configured to:
translate a first identifier from the request into a second identifier, the second identifier identifying the chiplet within the chiplet assembly; and
route a version of the request to the chiplet based on the second identifier for execution at the chiplet.

2. The apparatus of claim 1, wherein the request is received via a platform interconnect.

3. The apparatus of claim 2, wherein the platform interconnect conforms to a Computer Express Link (CXL) family of standards.

4. The apparatus of claim 3, wherein the request is delivered to the set of interfaces via a CXL switch.

5. The apparatus of claim 3, wherein the request includes a CXL apparatus designation that corresponds to a chiplet.

6. The apparatus of claim 1, wherein the set of interfaces is configured to receive a request from the entity to allocate the chiplet, and wherein the processing circuitry is configured to:
update a data structure of the apparatus to map the second identifier to the first identifier; and
notify the entity that the chiplet is allocated.

7. The apparatus of claim 6, wherein the processing circuitry is configured to generate an interrupt in the chiplet assembly to indicate that the chiplet is not available to the chiplet assembly.

8. The apparatus of claim 6, wherein the processing circuitry is configured to modify a routing device of the apparatus to prevent traffic from the chiplet to a second chiplet in the chiplet assembly and to prevent traffic from the second chiplet to the chiplet.

9. The apparatus of claim 6, wherein the set of interfaces is configured to receive a discovery request, and wherein the processing circuitry is configured to provide a response to the discovery request that the chiplet is available.

10. The apparatus of claim 9, wherein the response includes a time-based restriction on availability of the chiplet.

11. A non-transitory machine-readable media including instructions for chiplet composability, the instructions, when executed by processing circuitry, cause the processing circuitry to perform operations comprising:
receiving, at an input-output (IO) hub of a chiplet assembly, a request for a chiplet of the chiplet assembly, the request from an entity external to the chiplet assembly;
translating a first identifier from the request into a second identifier, the second identifier identifying the chiplet within the chiplet assembly; and
routing a version of the request to the chiplet based on the second identifier for execution at the chiplet.

12. The non-transitory machine-readable media of claim 11, wherein the request is received via a platform interconnect.

13. The non-transitory machine-readable media of claim 12, wherein the platform interconnect conforms to a Computer Express Link (CXL) family of standards.

14. The non-transitory machine-readable media of claim 13, wherein the request is delivered to the IO hub via a CXL switch.

15. The non-transitory machine-readable media of claim 13, wherein the request includes a CXL apparatus designation that corresponds to a chiplet.

16. The non-transitory machine-readable media of claim 11, wherein the operations comprise:
receiving a request from the entity to allocate the chiplet;
updating a data structure of the IO hub to map the second identifier to the first identifier; and
notifying the entity that the chiplet is allocated.

17. The non-transitory machine-readable media of claim 16, wherein the operations comprise generating an interrupt in the chiplet assembly to indicate that the chiplet is not available to the chiplet assembly.

18. The non-transitory machine-readable media of claim 16, wherein the operations comprise modifying a routing device of the IO hub to prevent traffic from the chiplet to a second chiplet in the chiplet assembly and to prevent traffic from the second chiplet to the chiplet.

19. The non-transitory machine-readable media of claim 16, wherein the operations comprise:
receiving a discovery request; and
providing a response to the discovery request that the chiplet is available.

20. The non-transitory machine-readable media of claim 19, wherein the response includes a time-based restriction on availability of the chiplet.
